(19) United States
(12) Patent Application Publication
(10) Pub. No.: US 2010/0291535 A1
(43) Pub. Date: Nov. 18, 2010

(54) METHOD USING MICROFLUIDIC CHIP TO SORT HIGH MOTILITY SPERM

(76) Inventors: Da-Jeng Yao, Hsinchu (TW); Tsung-Lin Wu, Hsinchu (TW); Fan-Gang Tseng, Hsinchu (TW); Li-Chern Pan, Taipei City (TW); Hong-Yuan Huang, Taoyuan (TW)

Correspondence Address: Muncy, Geissler, Olds & Lowe, PLLC, 4000 Legato Road, Suite 310, FAIRFAX, VA, 22033, US

(21) Appl. No.: 12/546,267

(22) Filed: Aug. 24, 2009

(30) Foreign Application Priority Data
May 15, 2009 (TW) 98116079

(51) Int. Cl. A01N 1/02

(52) U.S. Cl. 435/2

(57) ABSTRACT

The present invention discloses a method using a microfluidic chip to sort high motility sperm. In the present invention, sperm and a medium are respectively injected into a microchannel of a microfluidic chip via several inlets. Owing to the characteristic of microfluidics, the sperm and the medium form a sperm laminar flow and medium laminar flow in the microchannels; the sperm laminar flow and the medium laminar flow are parallel to each other. The higher motile sperm may pass through at least one laminar flow within a limited time, whereby different motility levels of sperm can be respectively collected from different outlets.

### FIELD OF THE INVENTION

The present invention relates to a method using a microfluidic chip to sort high motility sperm, particularly by using a microfluidic technology effectively obtaining high motility sperm from patient's samples.

### BACKGROUND OF THE INVENTION

Reproductive medicine has been an important medical field for the recent ten years. Reports show that there are averagely fifteen couples with reproductive disorder (the female one cannot be fertilized in a normal way) among a hundred couples. Among the couples having reproductive disorder, 30% of infertility is attributed to males, and 20% of them is attributed to both males and females. As about 50% infertility originates from abnormal or insufficient sperm, the research about sperm cells is very important in reproductive medicine. The state-of-the-art reproductive medical technology has been able to solve a portion of male infertility via ART (Assisted Reproductive Technology). IVE (In Vitro Fertilization) and ICSI (Intracytoplasmic Sperm Injection) are obvious examples among ART.

In ART, sperm are usually sorted before the fusion of sperm and an ovum, wherein good sperm are left from semen and bad ones are excluded, whereby only the top-quality sperm cells have a chance to impregnate into the ovum. The traditional sperm sorting methods include the swim-up method, the density gradient centrifugation method, the glass wool filtration method, and the migration sedimentation method, etc. After the above mentioned sorting processes, the professional medical personnel still have to select appropriate sperm cells from the sorted sperm via a microscope, which is a labor-consuming work. Further, the traditional sorting processes impair the quality of sperm cells more or less.

To reduce time-consuming work and decrease harm of sperm cells, a microfluidic technology has been used to sort sperm cells at present. According to the characteristic of microfluidic technology, a fluid features separate laminar flows without intermixing under low flow rate inside microchannel. Therefore, a fluid has a predictable phenomenon of laminar flows in micro-scale. The predictability is widely applied to separate cells, including sorting high-motility sperm. In an U.S. application Ser. No. 10/559,742, Takayama et al. disclosed a microfluidic device for sorting sperm, which has a channel, a sperm inlet and a motile particle-depleted sort stream outlet. The sperm inlet and the motile particle -depleted sort stream outlet respectively extend straight from two ends of the channel. The channel also has a medium inlet corresponding to the sperm inlet with an input angle contained by the medium inlet and the channel. The channel also has a motile particle-enriched sort stream outlet corresponding to the motile particle-depleted sort stream outlet with an output angle contained by the motile particle-enriched sort stream outlet and the channel. During operation, sperm and a medium are respectively injected from the sperm inlet and the medium inlet. Owing to the characteristic of microfluidics, the sperm and the medium respectively form laminar flows; the sperm laminar flow and the medium laminar flow respectively flow toward the motile particle-depleted sort stream outlet and the motile particle-enriched sort stream outlet. When the sperm laminar flow and the medium laminar flow are flowing inside the microchannel, the high-motility sperm move across the boundary from the sperm laminar flow to the medium laminar flow because of their high motility. Thus, the medium laminar flow carries the high-motility sperm toward the motile particle-enriched sort stream outlet, and the sperm laminar flow carries the residual lower-motility sperm toward the motile particle-depleted sort stream outlet. Then, the high-motility sperm are obtained from the motile particle-enriched sort stream outlet and used to increase the possibility of fertilization.

Takayama et al. evaluate the motility of sperm according to whether sperm can pass through the interface of the laminar flows. However, an essay entitled “Development of Sorting, Aligning, and Orienting Motile Sperm Using Microfluidic Device Operated by Hydrostatic Pressure”, by Seo et al., in Microfluid Nanofluid, vol. 3, pp. 561-570, 2007, reported a phenomenon that sperm do not necessarily swim randomly but may swim toward specified directions, which was ignored by other research teams before then. In the device of Takayama et al., sperm tend to move straight, and the sperm laminar flow carries the sperm toward the motile particle-depleted sort stream outlet; sperm cannot swim to the medium laminar flow. Consequently, the medium laminar flow does not carry the sperm toward the motile particle-enriched sort stream outlet. Thus, even the high-motility sperm may also be excluded by the device of Takayama et al. Therefore, the device of Takayama et al. lacks sufficient sorting capability. The motility of sperm has a considerable distribution. However, Takayama et al. uses only a single threshold to sort sperm in the patent thereof. Thus, the motile particle-enriched sort stream outlet of the device of Takayama et al. can obtain motile sperm, but the motility thereof is not necessary high enough. Then, the sperm obtained in the motile particle-enriched sort stream outlet need to be further screened by other apparatuses to distinguish high-motility sperm from lower-motility sperm, which should consume additional manpower and time.

### SUMMARY OF THE INVENTION

One objective of the present invention is to sort motile sperm in various directions and promote the quality of sorted sperm.

To achieve the above mentioned objective, the present invention proposes a method using a microfluidic chip to sort high motility sperm, which comprising steps:

providing a microfluidic chip having a microchannel with a medium inlet and a high motile sperm outlet, wherein the medium inlet and the high motile sperm outlet respectively extend straight from two ends of the microchannel, and wherein the microchannel also has a sperm inlet corresponding to the medium inlet with an input angle contained by the sperm inlet and the microchannel, and wherein the microchannel also has a low motile sperm outlet corresponding to the high motile sperm outlet with an output angle contained by the low motile sperm outlet and the microchannel;

respectively injecting a medium and sperm into the microchannel via the medium inlet and the sperm inlet, wherein the medium and the sperm respectively form a medium laminar flow and a sperm laminar flow inside the microchannel, which then respectively flow toward the high motile sperm outlet and the low motile sperm outlet; and

separating sperm, wherein owing to the input angle between the sperm inlet and the medium inlet, the high-motility sperm in the sperm laminar flow move to the medium laminar flow, and the medium laminar flow carries the high-motility sperm toward the high motile sperm outlet, and wherein the sperm laminar flow carries the lower-motility sperm toward the low motile sperm outlet, whereby the high motile sperm can be sorted from the sperm.

Another objective of the present invention is to sort sperm according to the levels of motility.

To achieve the above mentioned objective, the present invention further proposes another method using a microfluidic chip to sort high motility sperm, which comprising steps:

providing a microfluidic chip having a microchannel, wherein two ends of the microchannel respectively has a plurality of inlets and a plurality of outlets corresponding to the inlets;

injecting a medium and sperm, wherein the sperm is fed via one inlet, and the medium is fed via the other inlets, and wherein the sperm forms a sperm laminar flow inside the microchannel, and the sperm laminar flow flows through the microchannel to the corresponding outlet, and wherein the medium fed via the other inlets form a plurality of medium laminar flows, and the medium laminar flows flow through the microchannel to the corresponding outlets; and

separating sperm, when the sperm laminar flow and a plurality of medium laminar flows flow inside the microchannel, the sperm of the sperm laminar flow move to different medium laminar flows owing to different levels of motility, and the medium laminar flows respectively carry sperm having different levels of motility to their corresponding outlets.

### BRIEF DESCRIPTION OF THE DRAWINGS

FIG. 1 is a flowchart of a method using a microfluidic chip to sort high motility sperm according to one aspect of the present invention;

FIG. 2 is a flowchart of a method using a microfluidic chip to sort high motility sperm according to another aspect of the present invention;

FIGS. 3A-3C are diagrams schematically showing the steps according to a first embodiment of the present invention;

FIG. 4 is a diagram showing the quantities of various grades of sperm in the experiments verifying the first embodiment of the present invention;

FIG. 5 is a diagram showing the proportion of various grades of sperm in the experiments verifying the first embodiment of the present invention;

FIGS. 6A-6C are diagrams schematically showing the steps according to a second embodiment of the present invention;

FIG. 7 is a diagram showing the quantities of various grades of sperm in the experiments verifying the second embodiment of the present invention;

FIG. 8 is a diagram showing the proportion of various grades of sperm in the experiments verifying the second embodiment of the present invention; and

FIG. 9 is a diagram schematically showing a microfluidic chip according to another aspect of the second embodiment of the present invention.

### DETAILED DESCRIPTION OF THE PREFERRED EMBODIMENTS

Below, the technical contents of the present invention are described in detail in cooperation with the drawings.

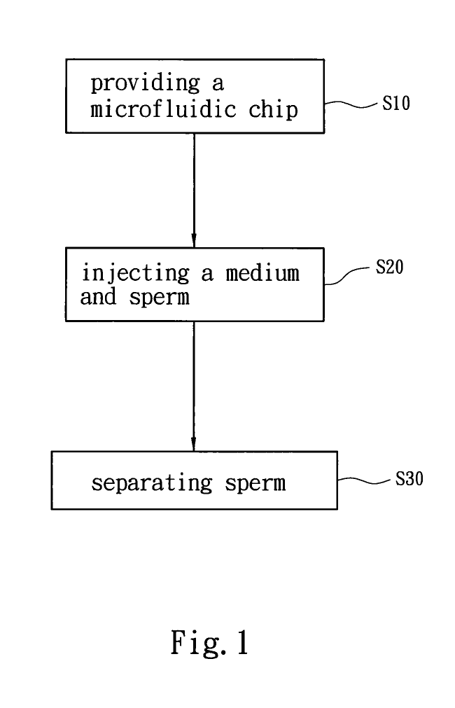

Refer to FIG. 1. The present invention proposes a method using a microfluidic chip to sort high motility sperm, which comprises

Step S10: providing a microfluidic chip having a microchannel with an inlet and an outlet respectively formed on two ends of the microchannel;

Step S20: respectively injecting a medium and sperm into the microchannel via the inlet to separately form a medium laminar flow and a sperm laminar flow, wherein the medium laminar flow and the sperm laminar flow move through the microchannel toward the outlets; and

Step S30: separating sperm, owing to the input angle between the sperm inlet and the medium inlet, the high-motility sperm in the sperm laminar flow move to the medium laminar flow, and the medium laminar flow carries the high-motility sperm flow toward the high motile sperm outlet, and wherein the sperm laminar flow carries the lower-motility sperm flow toward the low motile sperm outlet, whereby the high motile sperm can be sorted from the sperm.

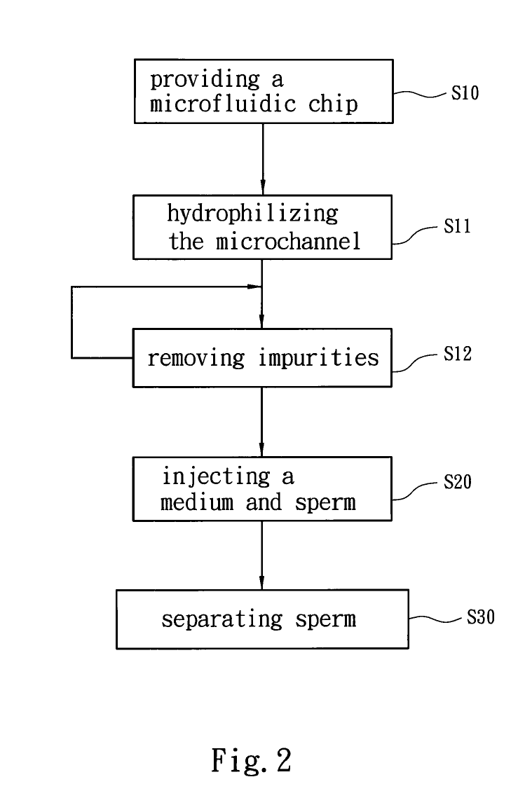

Refer to FIG. 2. The method of the present invention may further comprise a hydrophilization step of microchannel (Step 11) to enhance the hydrophilicity of the microchannel and thus avoid the nonspecific adherence between sperm and microchannel which may cause the microchannel block. The method of the present invention may further comprise an impurity-removing step (Step 12) to remove impurities in sperm. The impurity-removing step may be performed repeatedly to gradually lower impurity content of sperm.

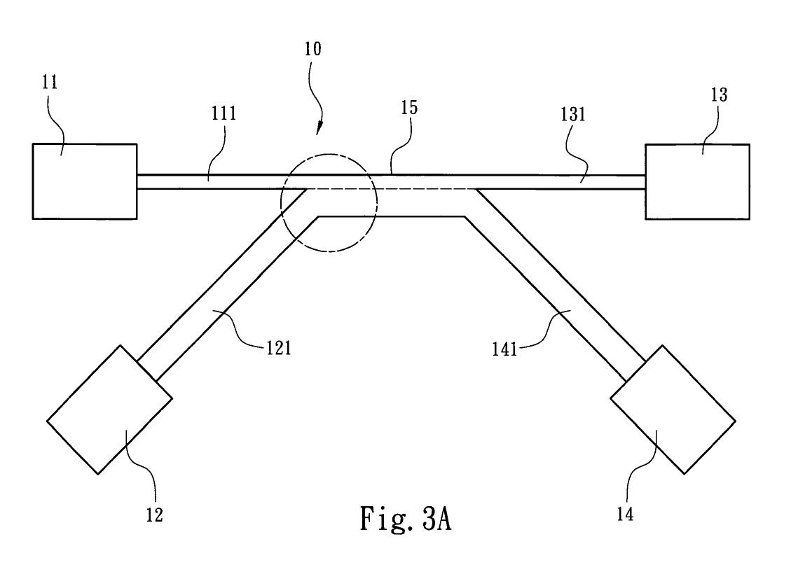

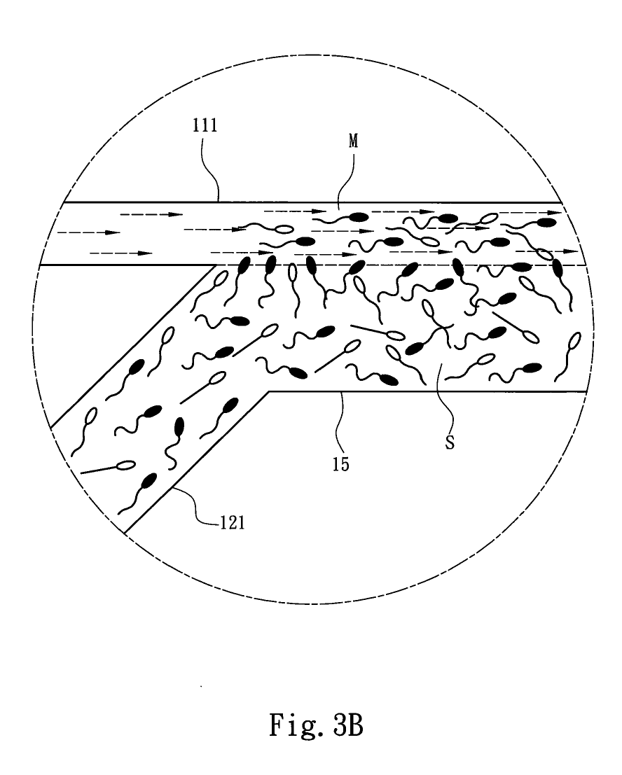

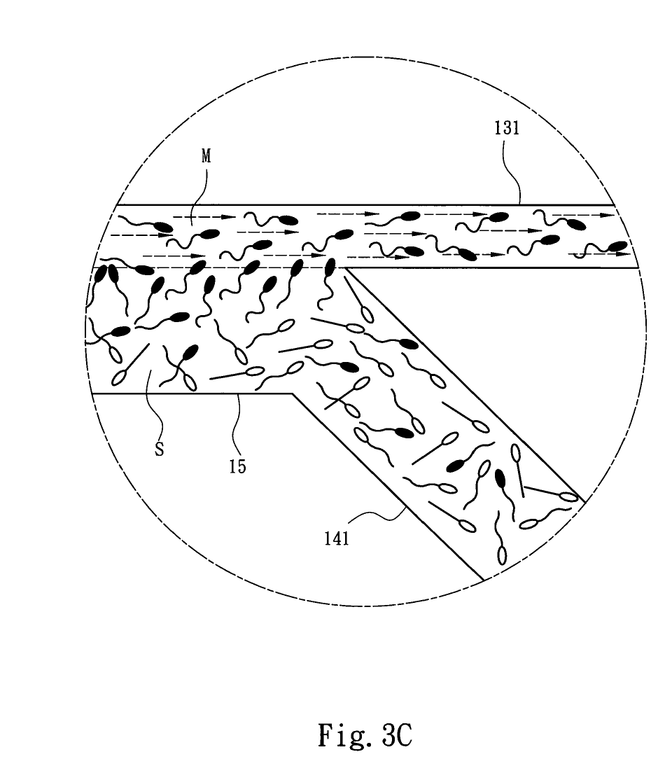

Refer to FIGS. 3A-3C for the detailed process of the present invention, wherein the sorting process is undertaken in a microfluidic according to a first embodiment of the present invention. In Step S10 of providing a microfluidic chip, a microfluidic chip 10 with a microchannel 15 is prepared. As shown in FIG. 3A, a medium inlet 11 and a high motile sperm outlet 13 respectively extend straight from two ends of the microchannel 15. The medium inlet 11 and the high motile sperm outlet 13 respectively have an input branch microchannel 111 and an output branch microchannel 131, which are respectively connected to the microchannel 15. The microchannel 15 also has a sperm inlet 12 forming an input angle with medium inlet 11. The microchannel 15 lo also has a low motile sperm outlet 14 forming an output angle with the high motile sperm outlet 13. The sperm inlet 12 and the low motile sperm outlet 14 respectively have an input branch microchannel 121 and an output branch microchannel 141, which are respectively connected to the microchannel 15. In Step S11 of hydrophilization of microchannel, a hydrophilic solution, such as BSA (Bovin Serum Albumin), is injected into the microchannel 15 and then sucked out from the microchannel 15. Next is performed Step S12 to remove impurities. For example, sperm is added into a diluent, and the diluted sperm is placed statically to enable the deposition of impurities in the sperm; then, the supernatant liquid is collected. For another example, an enchyma is added to sperm, and the mixture solution is centrifugalized; the sediment in the bottom of the mixture solution is collected. For a further example, sperm is shaken and centrifugalized; then, the supernatant liquid is collected. According to the content of impurities in sperm or the required impurity level, Step S12 may be performed repeatedly to minimize the content of impurities. Next is performed Step S20 to inject a medium and sperm. The medium is injected into the medium inlet 11, and the impurity-removed sperm is injected into the sperm inlet 12. The medium inlet 11 and the sperm inlet 12 respectively have level differences with respect to the high motile sperm outlet 13 and the low motile sperm outlet 14, which can provide sperm-harmless flow ability. As shown in FIG. 3B, owing to the characteristic of microfluid, the medium forms a medium laminar flow M passing through the microchannel 15 toward the high motile sperm outlet 13, and the sperm forms a sperm laminar flow S passing through the microchannel 15 toward the low motile sperm outlet 14. In the drawings, the black-head sperm denote the high-motility sperm, and the white-head sperm denote the lower-motility sperm. Next is performed Step S30 to separate sperm. The medium inlet 11 extends straight to the microchannel 15, and the sperm inlet 12 has an input angle with respect to the medium inlet 11. When sperm and a medium are respectively injected into the microchannel 15, the motile sperm moving in an approximate straight direction directly rush through the interface between the sperm laminar flow S and the medium laminar flow M and reach the medium laminar flow M. The motile sperm moving in other directions may also swim to the medium laminar flow M by their own motility. As shown in FIG. 3C, no matter what direction the motile sperm advance to, most of the high motile sperm are gathered in the high motile sperm outlet 13. Thereby, motile sperm can be effectively sorted.

Experiments are used to verify that the sorting capability of the first embodiment of the present invention is better than the U.S. Pat. No. 10/559,472. The present invention serves as the experimental groups, and the U.S. Pat. No. 10/559,472 serves as the control groups. Below are the experimental conditions: the sperm is a diluted hog sperm sourced from ATIT (Animal Technology Institute Taiwan); the diluted hog sperm has a concentration of 10⁸ cells/80 c.cc, and the motility thereof can maintain for 2-3 days at 20° C.; each of the input branch microchannels 111 and 121 and the output branch microchannels 131 and 141 has a width of 200 μm; the microchannel 15 has a width of 400 μm; all the above mentioned microchannel and branch microchannels have a height of 50 μm; the input angle and the output angle are both equal to 45 degrees. In the experiments, there are three experimental groups and three control groups used to estimate the quantities of the sperm collected in the high motile sperm outlets thereof. Five samples of sperm are obtained from each high motile sperm outlet. The spermatozoa in each sample are respectively scored, and the quantities of the spermatozoa of the same score point in the same groups are averaged. The score is determined according to the following rules:

Score 2: having an effective movement;

Score 1: having none effective movement but turning around;

Score 0: having none movement.

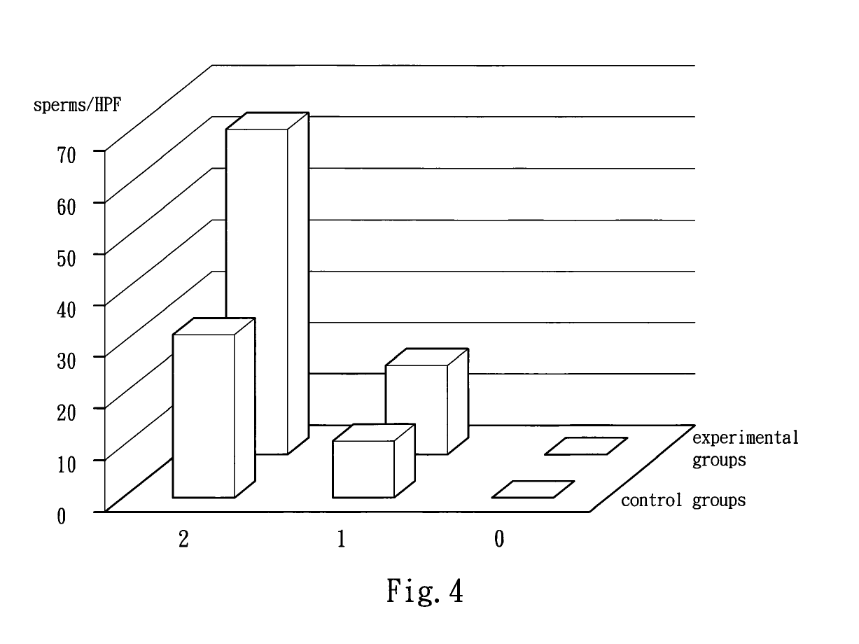

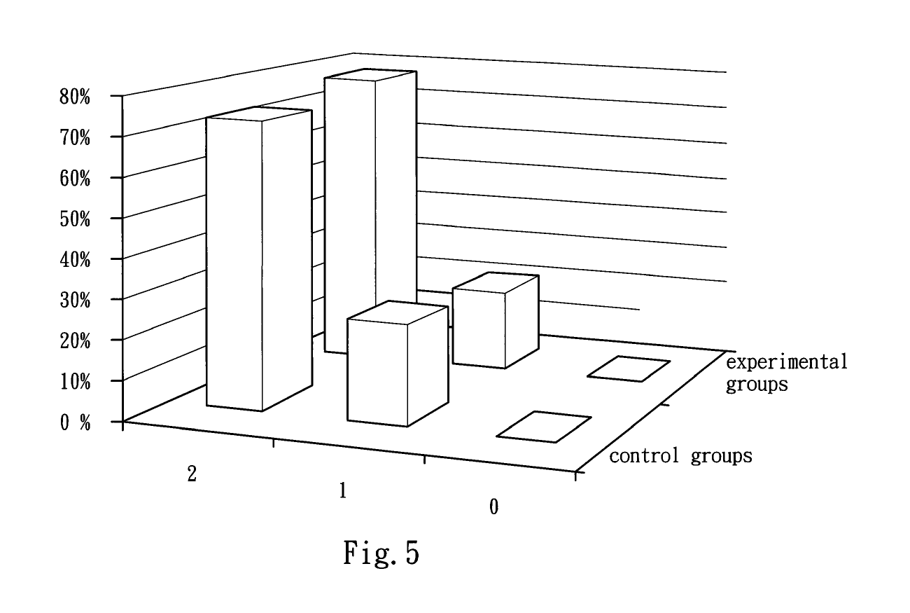

FIG. 4 shows that the efficiency of the experimental groups is more than 50% higher than that of the control groups in sorting high-motility sperm. The sperm scoring “2” or scoring “1” increases considerably in the experimental groups. Refer to FIG. 5 for the proportions of the sperm scoring different points in the high motile sperm outlets. No matter in the experimental groups or the control groups, the sperm scoring “2” are about 70%, and the sperm scoring “1” are about 30%. The sperm proportions of score 2 and score 1 are about identical in the experimental groups and the control groups because the sperm comes from the same source. However, the quantities of the 2-point sperm and the 1-point sperm are obviously higher in the experimental groups. Therefore, the present invention is superior to the U.S. patent Ser. No. 10/559,742 in sorting high motile sperm.

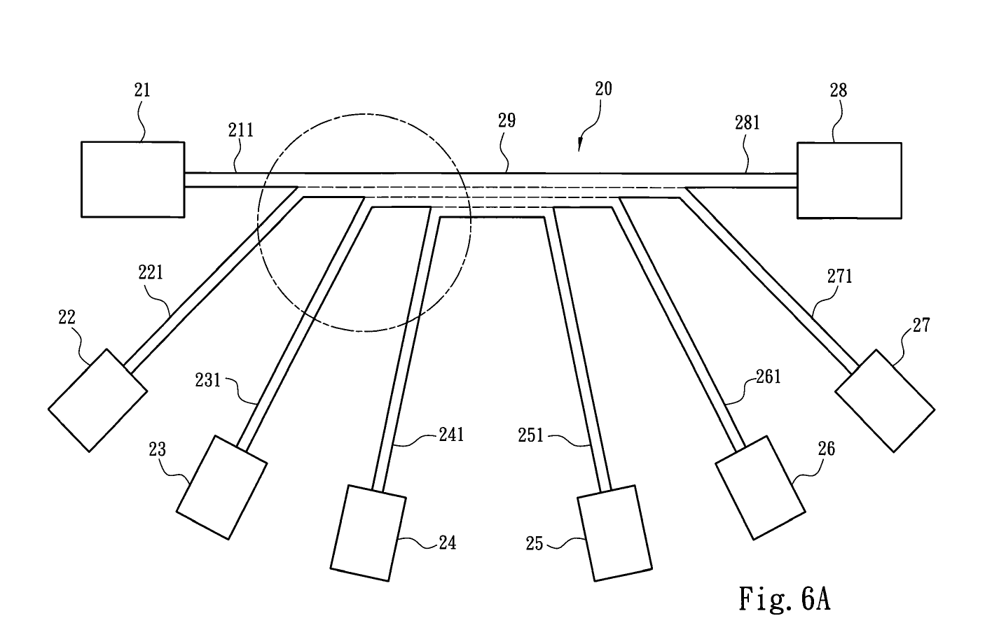

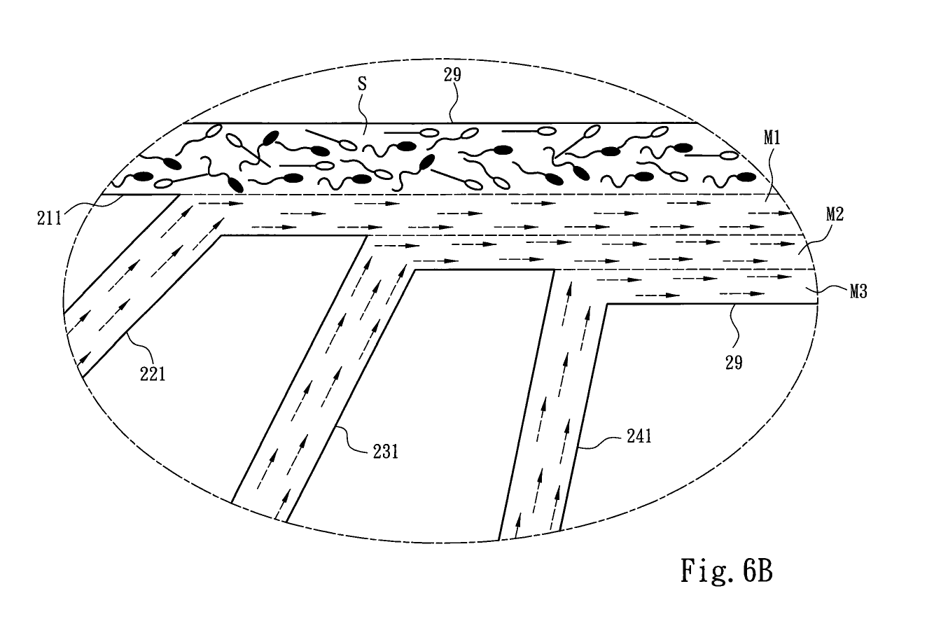

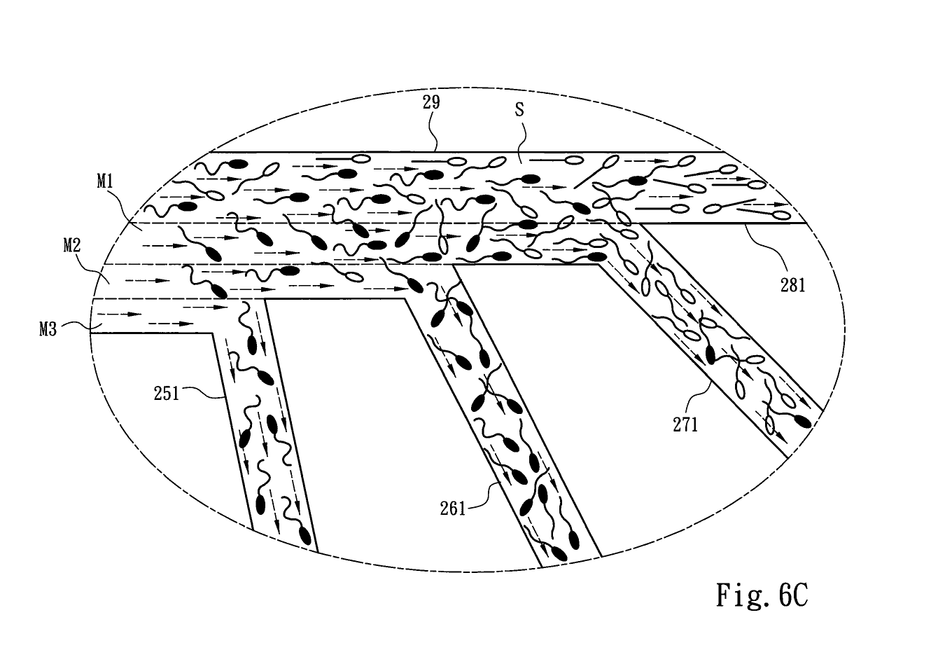

Refer to FIGS. 6A-6C. A second embodiment of the present invention proposes a method using a microfluidic chip to respectively sort sperm by the motility grades thereof. The second embodiment is basically similar to the first embodiment. In the second embodiment, firstly is performed Step S10 to provide a microfluidic chip; next is performed Step S11 to hydrophilize the microchannel of the microfluidic chip; next is performed Step S12 to remove impurities of sperm; next is performed Step 20 to inject sperm and a medium; next is performed Step S30 to separate sperm. The second embodiment is different from the first embodiment in the microfluidic chip provided in Step S10. As shown in FIG. 6A, in the second embodiment, the microfluidic chip 20 has a microchannel 19; a plurality of inlets and a plurality of outlets are respectively formed on two ends of the microchannel 19. In the drawings, there are four inlets and four outlets. However, they are only the exemplification of the input and outlets. The present invention does not limit the inlets and outlets to have a configuration of 4-to-4 but may have another configuration of the inlets and outlets. After Step S12 (removing impurities), sperm is injected into one of the inlets. In the second embodiment, sperm is lo injected into the topmost inlet, and the topmost inlet is thus defined as a sperm inlet 21. The sperm inlet 21 has an input branch microchannel 211 connecting to the microchannel 29. The other three inlets respectively used to inject the medium denoted as medium inlets 22, 23 and 24. The medium inlets 22, 23 and 24 respectively have input branch microchannels 221, 231 and 241, which connect to the microchannel 29. As shown in FIG. 6B, sperm and a medium are fed into the microchannel 29 respectively via the sperm inlet 21, the medium inlets 22, 23 and 24 to form a sperm laminar flow S and three medium laminar flows M1, M2 and M3, which flow through the microchannel 29 and respectively reach the corresponding outlets. The four outlets are respectively defined to be a first order outlet 25, a second order outlet 26, a third order outlet 27 and a fourth order outlet 28. The outlets 25, 26, 27 and 28 respectively have output branch microchannels 251, 261, 271 and 281, which connect to the microchannels 29. When the sperm laminar flow S and the medium laminar flows M1, M2 and M3 are flowing in the microchannel 29, the motile sperm in the sperm laminar flow S may swim to the medium laminar flows M1, M2 or M3 according to the motility thereof. As shown in FIG. 6C, the sperm having the highest motility may reach the third (the bottommost) medium laminar flow M3, and the medium laminar flow M3 will carry them into the first order outlet 25. The sperm having the secondary motility may reach the second medium laminar flow M2, and the medium laminar flow M2 will carry them into the second order outlet 26. The weaker motile sperm will reach the first medium laminar flow M1, and the medium laminar flow M2 will carry them into the third order outlet 27. The immotile sperm in the sperm laminar flow S would not swim to any medium laminar, and the sperm laminar flow S will carry them into the fourth order outlet 28. The sperm can be graded and separately collected according to their motility by the movement of sperm toward different medium laminar flows M1, M2 and M3. Experiments are used to verify that the graded sorting capability of the second embodiment of the present invention. The experimental conditions are the same as those used in verifying the first embodiment. Below are the experimental conditions: the sperm is a diluted hog sperm sourced from ATIT (Animal Technology Institute Taiwan); the diluted hog sperm has a concentration of 10⁸ cells/80 c.cc, and the motility thereof can maintain for 2-3 days at 20° C.; each of input branch microchannels 211, 221, 231 and 241 and the output branch microchannels 251, 261, 271 and 281 has a width of 200 μm; the microchannel 29 has a width of 400 μm; all the above mentioned microchannel and branch microchannels have a height of 50 μm; the input angle and the output angle are both equal to 45 degrees. Makler counting chamber is used to analyze the sperm collected in each order of outlets 25, 26, 27 and 28. The Makler counting chamber has 10×10 grids at the center thereof, and each grid has a width of 100 μm. Micropipettes are used to respectively absorb samples from the sperm inlet 21 and all orders of outlets 25, 26, 27 and 28, and the samples are respectively placed on Makler counting chamber for observation. The motile sperm are scored in the following rule:

Score 4: sperm swim forward rapidly (at a speed of more than 50 μm/sec), and the motion of the tails is too fast to be seen clearly;

Score 3: sperm swim forward rapidly (at a speed of more than 50 μm/sec), but the motion of the tails can be seen clearly;

Score 2: sperm swim forward slowly (at a speed of less than 50 μm/sec);

Score 1: sperm can only turn around (at a speed of 50 μm/sec);

Score 0: sperm are immotile.

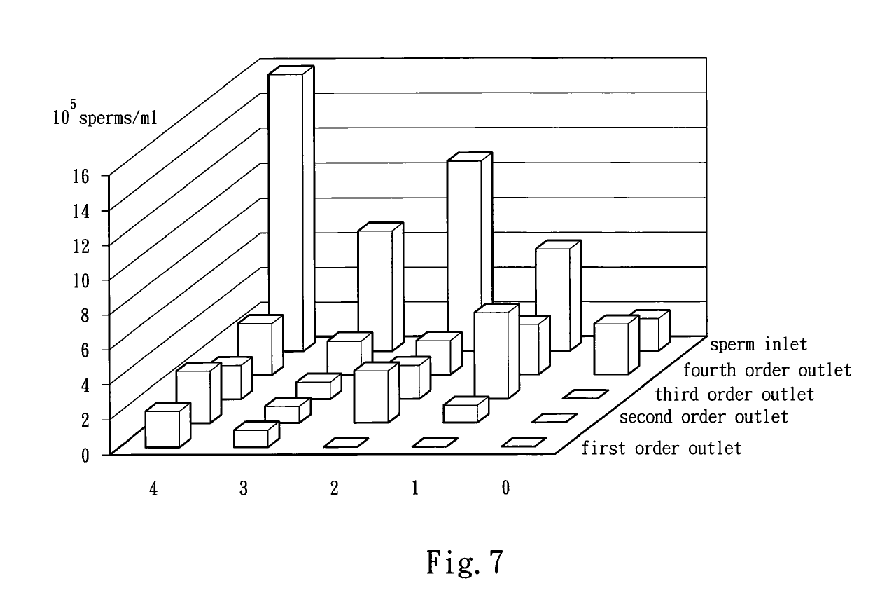

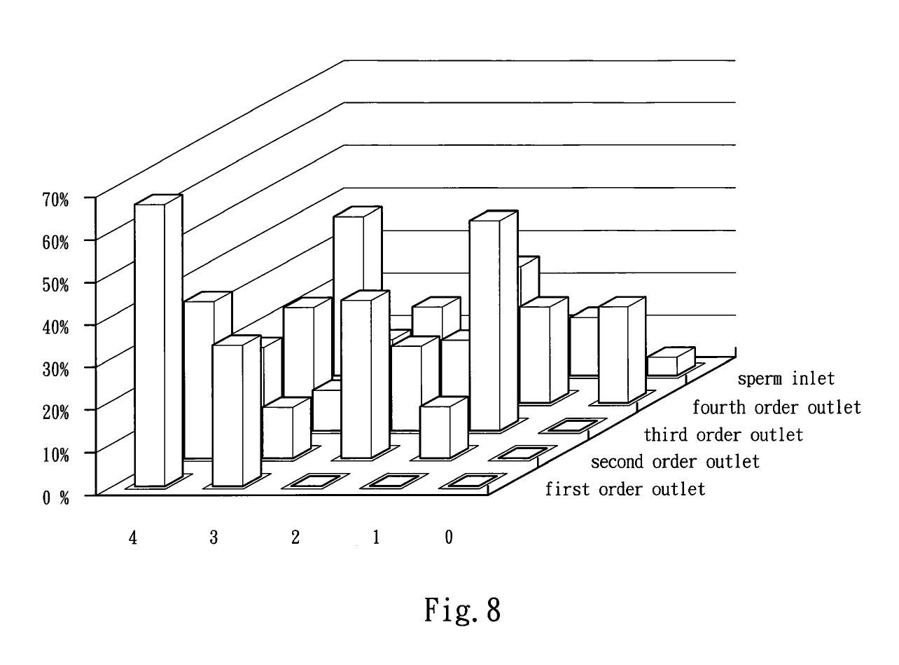

Refer to FIG. 7. The sperm collected in the fourth order outlet 28 can still have various levels of motility. As a potion of motile sperm have been sorted and collected elsewhere, the quantity of the sperm collected in the fourth order outlet 28 is much less than that in the sperm inlet 21. The first order outlet 25 with the highest threshold, which is used to collect the highest motile sperm, has the least quantities. The second order outlet 26 and the third order outlet 27 have both high-motility and low-motility sperm and it excluded immotile sperm due to their limitation of threshold. FIG. 8 shows the proportion of sperm with various motility level collected in the outlets 25, 26, 27 and 28. As having a lower threshold, the fourth order outlet 28 has various grades of sperm. The higher motile sperm are likely to reach the other outlets; therefore, the higher the grade of sperm (the higher the score), the lower the proportion of the sperm in the fourth order outlet 28. In the other three outlets 25, 26 and 27, it can be seen that the higher the threshold a field has, the more the higher-grade sperm the field has. In the first order outlet 25, the highest-motility sperm are even over 60%.

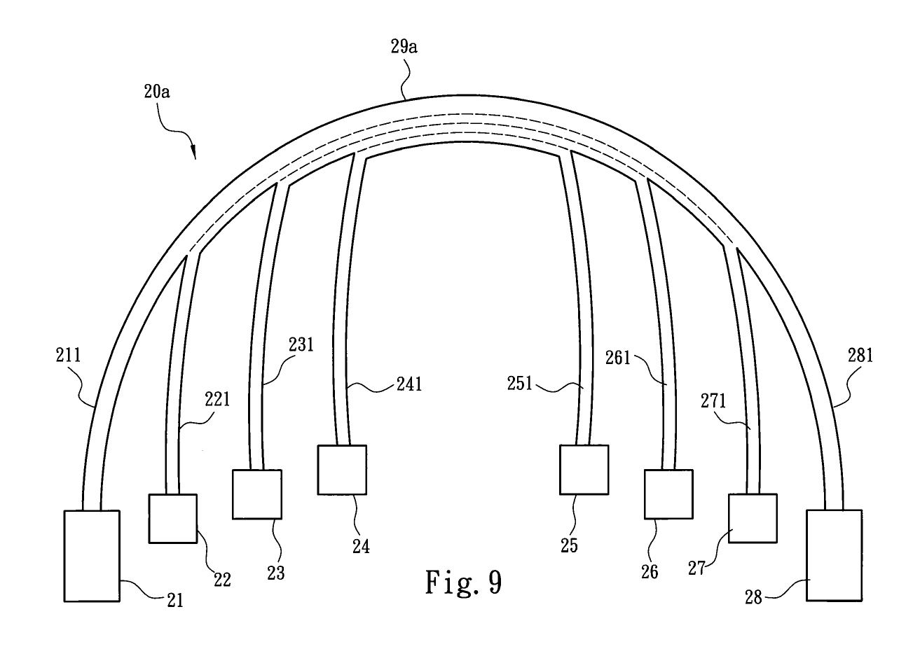

Refer to FIG. 9 for another aspect of the second embodiment. In order to avoid the sperm with straight movement only following the sperm laminar flow S and flowing toward the fourth order outlet 28 and thus caused the problem of the inefficient sorting capability. The second embodiment of the present invention also proposes a microfluidic chip 20a with a non-straight microchannel 29a. When the straight-moving sperm advance in the non-straight microchannel 29a, they will bump against the wall of the non-straight microchannel 29a and change their directions, whereby the straight-moving sperm can move to the medium laminar flow s M1, M2 and M3 and then be sorted out.

The embodiments described above are only to exemplify the present invention but not to limit the scope of the present invention. Any equivalent modification or variation according to the spirit or technical contents of the present invention is also included within the scope of the present invention.

What is claimed is:

1. A method using a microfluidic chip to sort high motility sperm comprising
a step of providing a microfluidic chip, wherein said microfluidic chip has a microchannel with a medium inlet and a high motile sperm outlet respectively extending straight from two ends of said microchannel, and wherein said microchannel also has a sperm inlet forming an input angle with said medium inlet and connecting to said microchannel, and wherein said microchannel also has a low motile sperm outlet forming an output angle with said high motile sperm outlet and connecting to said microchannel;
a step of injecting sperm and a medium, wherein said medium and said sperm are respectively fed into said microchannel via said medium inlet and said sperm inlet, and wherein said medium and said sperm respectively form a medium laminar flow and a sperm laminar flow inside said microchannel, and wherein said medium laminar flow and said sperm laminar flow respectively flow toward said high motile sperm outlet and said low motile sperm outlet; and
a step of separating sperm, wherein owing to said input angle between said sperm inlet and said medium inlet, high-motility sperm in said sperm laminar flow move to said medium laminar flow, and said medium laminar flow carries said high-motility sperm toward said high motile sperm outlet, and wherein said sperm laminar flow carries lower-motility sperm toward said low motile sperm outlet, whereby sperm having better motility can be sorted from said sperm.

2. The method using a microfluidic chip to sort high motility sperm according to claim 1 further comprising a step of decreasing impurities of said sperm before said step of injecting sperm and a medium.

3. The method using a microfluidic chip to sort high motility sperm according to claim 2, wherein said step of decreasing impurities of said sperm is repeated to decrease impurity content of said sperm.

4. The method using a microfluidic chip to sort high motility sperm according to claim 2, wherein said step of decreasing impurities of said sperm includes adding said sperm into a diluent; placing a mixture solution of said sperm and said diluent statically to enable the disposition of impurities in said sperm; and collecting a supernatant liquid from said mixture solution that has been placed statically.

5. The method using a microfluidic chip to sort high motility sperm according to claim 2, wherein said step of decreasing impurities of said sperm includes adding an enchyma to said sperm; centrifugalizing a mixture solution of said sperm and said enchyma; collecting a sediment in the bottom of said mixture solution that has been centrifugalized.

6. The method using a microfluidic chip to sort high motility sperm according to claim 2, wherein said step of decreasing impurities of said sperm includes shaking said sperm and then centrifugalizing said sperm; and collecting a supernatant liquid from said sperm that has been shaken and centrifugalized.

7. The method using a microfluidic chip to sort high motility sperm according to claim 1 further comprising a step of hydrophilizing said microchannel before said step of injecting said sperm and said medium to increase hydrophilicity of said microchannel lest nonspecific adherence of said sperm block said microchannel.

8. A method using a microfluidic chip to sort high motility sperm comprising
a step of providing a microfluidic chip, wherein said microfluidic chip has a microchannel with a plurality of inlets and a plurality of outlets corresponding to said inlets, wherein said inlets and said outlets are respectively formed on two ends of said microchannel;
a step of injecting sperm and a medium, wherein said sperm is fed via one said inlet, and said medium is fed via the other said inlets, and wherein said sperm forms a sperm laminar flow inside said microchannel, and said sperm laminar flow flows through said microchannel to the corresponding said outlet, and wherein said medium fed via the other said inlets form a plurality of medium laminar flows, and said plurality of medium laminar flows flow through said microchannel to the corresponding said outlets; and
a step of separating sperm, wherein when said sperm laminar flow and said medium laminar flows advance inside said microchannel, motile sperm of said sperm laminar flow move to different said medium laminar flows according to different levels of motility thereof, whereby sperm having different levels of motility respectively move to said medium laminar flows, and said medium laminar flows respectively carry sperm having different levels of motility flow toward the corresponding said outlets.

9. The method using a microfluidic chip to sort high motility sperm according to claim 8, wherein said inlets are respectively defined to be a sperm inlet and medium inlets from one end to another end.

10. The method using a microfluidic chip to sort high motility sperm according to claim 9, wherein corresponding to said sperm inlet and said medium inlets, said outlets are sequentially defined to be a fourth order outlet, a third order outlet, a second order outlet and a first order outlet.

11. The method using a microfluidic chip to sort high motility sperm according to claim 8, wherein said microchannel is straight.

12. The method using a microfluidic chip to sort high motility sperm according to claim 8, wherein said microchannel is non-straight.

13. The method using a microfluidic chip to sort high motility sperm according to claim 8 further comprising a step of decreasing impurities of said sperm before said step of injecting sperm and a medium.

14. The method using a microfluidic chip to sort high motility sperm according to claim 13, wherein said step of decreasing impurities of said sperm is repeated to decrease impurity content of said sperm.

15. The method using a microfluidic chip to sort high motility sperm according to claim 13, wherein said step of decreasing impurities of said sperm includes adding said sperm into a diluent; placing a mixture solution of said sperm and said diluent statically to enable the disposition of impurities in said sperm; and collecting a supernatant liquid from said mixture solution that has been placed statically.

16. The method using a microfluidic chip to sort high motility sperm according to claim 13, wherein said step of decreasing impurities of said sperm includes adding an enchyma to said sperm; centrifugalizing a mixture solution of said sperm and said enchyma; collecting a sediment in the bottom of said mixture solution that has been centrifugalized.

17. The method using a microfluidic chip to sort high motility sperm according to claim 13, wherein said step of decreasing impurities of said sperm includes shaking said sperm and then centrifugalizing said sperm; and collecting a supernatant liquid from said sperm that has been shaken and centrifugalized.

18. The method using a microfluidic chip to sort high motility sperm according to claim 8 further comprising a step of hydrophilizing said microchannel before said step of injecting said sperm and said medium to increase hydrophilicity of said microchannel lest nonspecific adherence of said sperm block said microchannel.
